(19) United States
(12) Patent Application Publication
(10) Pub. No.: US 2023/0203992 A1
(43) Pub. Date: Jun. 29, 2023

(54) GAS TURBINE ENGINE OF AN AIRCRAFT COMPRISING A TRANSMISSION

(71) Applicant: ROLLS-ROYCE DEUTSCHLAND LTD & CO KG, Blankenfelde-Mahlow (DE)

(72) Inventor: Björn PETERSEN, Berlin (DE)

(21) Appl. No.: 17/762,277

(22) PCT Filed: Sep. 15, 2020
(86) PCT No.: PCT/EP2020/075738

§ 371 Date: Sep. 16, 2022

(30) Foreign Application Priority Data
Sep. 27, 2019 (DE) 10 2019 126 093.0

(51) Int. Cl. F02C 7/36; F02C 7/06

(52) U.S. Cl. CPC F02C 7/36; F02C 7/06; F05D 2240/60

(57) ABSTRACT

A gas turbine engine includes with a gear box is arranged radially in an interior space which is delimited by a support structure fixed with respect to a casing and which is provided radially within a core air flow. Shafts of the gear box are rotatably mounted in the support structure. The interior space is configured to be oil-tight in relation to the surroundings of the support structure, at least in a radially outer region. A pump unit is provided, by which oil is applied to the gear box and which is connected in terms of drive to the gear box. The support structure includes a receiving region for the pump unit. The pump unit can be introduced into the receiving region from a region outside the interior space via an opening of the support structure and can be removed from the receiving region via the opening.

The present disclosure relates to a gas turbine engine with a gear box, which gear box is arranged at least partially radially in an interior space which is delimited by a support structure fixed with respect to a casing and which is provided radially within a core air flow.

U.S. Pat. No. 8,307,626 B2 has disclosed a gas turbine engine with a fan and with a compressor, which are connected to one another via a gear box arranged between the fan and the compressor in an axial direction. The gear box is arranged radially in an interior space which is delimited by a support structure fixed with respect to a casing, and shafts of the gear box are rotatably mounted in the support structure. The gas turbine engine comprises a pump system having a main pump and an auxiliary pump. The main pump supplies all components of the gas turbine engine with lubricant. For this purpose, the main pump can be driven by a high-pressure shaft, to which the main pump is connected via a gear box.

The auxiliary pump is driven by the fan via a gear box, such that the auxiliary pump conveys hydraulic fluid or lubricant whenever the fan is in motion. The auxiliary pump is rotatably mounted in the support structure and is arranged entirely in the interior space of the support structure.

It is disadvantageous that, in the event of a fault, the auxiliary pump can only be dismounted together with the support structure, which significantly increases the effort involved in maintenance.

It is sought to provide a structurally simple and inexpensive gas turbine engine, which is furthermore distinguished by low effort involved in maintenance.

This object is achieved by a gas turbine engine having the features of patent claim 1.

According to a first aspect, a gas turbine engine having a gear box is provided. The gear box is arranged radially in an interior space which is delimited by a support structure fixed with respect to a casing and which is provided radially within a core air flow. At least shafts of the gear box are rotatably mounted in the support structure. The interior space is configured to be oil-tight in relation to the core flow, at least in a radially outer region.

Furthermore, a pump unit is provided, by means of which oil can be applied to the gear box and which is connected in terms of drive to the gear box. The support structure is configured with a receiving region for the pump unit.

The gas turbine engine according to the present disclosure is distinguished, in a simple and inexpensive manner in terms of construction, by low effort involved in assembly and maintenance, because the pump unit can be introduced into the receiving region from a region outside the interior space via an opening of the support structure and can be removed from the receiving region via the opening.

If the pump unit projects into the interior space from the region outside the interior space through the opening of the support structure, the operative connection between the pump unit and the gear box can be produced in a simple manner.

A sealing unit may be provided between a casing of the pump unit and the support structure in the region of the opening in order, in a straightforward manner, to prevent an uncontrolled escape of oil from the interior space through the opening of the receiving region.

In a structurally simple embodiment of the gas turbine engine according to the present disclosure, the pump unit is fixedly connected to the support structure.

If the gear box is arranged between a fan and a compressor of the gas turbine engine in an axial direction of the gas turbine engine, and if the fan and the compressor are connected to one another via the gear box, the compressor and the fan can each be operated in a rotational speed range within which their respective efficiencies are high.

During the operation of the gas turbine engine, the oil supplied in the gear box by the pump unit is thrown off in a radially outward direction owing to the centrifugal force acting on the oil. In order to avoid an uncontrolled distribution of the thrown-off oil in the gas turbine engine, and in order to be able to conduct the oil to the oil reservoir in an efficient manner, it may be provided that, proceeding from a region facing toward the fan in the direction of a region facing toward the compressor, a radial spacing between a wall region of the support structure and an axis of rotation of the gas turbine engine initially increases to a maximum and then decreases again. It is additionally possible here that the maximum is provided at least approximately above that region between the fan and the compressor in which the gear box is arranged.

This embodiment offers the advantage that the oil thrown off by the gear box collects in the region of the maximum of the spacing between the wall region of the support structure and the axis of rotation of the gas turbine engine. The oil that collects in the region of the maximum can then, in a simple manner, for example via an outlet opening arranged in the region of the maximum of the radial spacing, be discharged from the interior space and supplied to an oil circuit of the gas turbine engine, to which oil circuit the pump unit is in turn operatively connected.

Furthermore, provision may also be made for the pump unit to draw in oil that has collected in the interior space in the region of the maximum of the radial spacing, and convey said oil in the direction of the gear box, via an oil line that runs through the interior space.

In this case, the oil circuit may correspond to a first oil circuit of the gas turbine engine, via which oil is applied to various regions of the gas turbine engine, such as bearings, heat exchangers and the like. Furthermore, it is also possible for the oil circuit to constitute a second oil circuit of the gas turbine engine, via which only the gear box can be supplied with oil by the pump unit. Here, the first oil circuit, which may then have a separate pump unit, and the second oil circuit may if necessary also be connected to one another or operatively connectable to one another.

In further design embodiments of the gas turbine engine according to the present disclosure, provision is made for the receiving region and the opening of the support structure to be provided in that region of the support structure which faces toward the fan or in that region of the support structure which faces toward the compressor. In this way, the pump unit can be installed or uninstalled in a straightforward manner, and exchanged with little installation effort in the event of a fault, with either the fan having been uninstalled or the compressor having been uninstalled.

The receiving region may be provided entirely outside the interior space, outside and within the interior space, or entirely within the interior space. Existing gas turbine engine systems can thus be implemented in accordance with the present disclosure without complex design measures.

If a drive shaft of the pump unit is operatively connected to a shaft of the gear box, the pump unit is driven by the gear box to the desired extent and supplies the gear box with oil.

If a gear box unit is provided between the drive shaft of the pump unit and the shaft of the gear box, the rotational speed of the drive shaft can be increased in relation to the rotational speed of the shaft of the gear box, and the pump unit can be dimensioned to be smaller and can thus be implemented in a structural-space-saving form.

A first shaft of the gear box may be connected to the fan via a fan shaft, and a second shaft of the gear box may be operatively connected to the compressor via a compressor shaft. It is thus in turn possible in a simple manner for the fan to be operated at a rotational speed that differs from the rotational speed of the compressor if the shafts of the gear box are connected to one another via toothed gears and a corresponding speed ratio.

Furthermore, the pump unit can then be driven in a structurally simple manner by the fan or by the compressor, and a supply of oil to the gear box is ensured over a large operating range of the gas turbine engine.

In further embodiments of the gas turbine engine according to the present disclosure that can be assembled and maintained with little effort, at least the first shaft of the gear box is rotatably mounted in a region of the support structure facing toward the fan, and/or at least the second shaft of the gear box is rotatably mounted in a region of the support structure facing toward the compressor.

In further structurally simple embodiments of the gas turbine engine according to the present disclosure, the fan shaft and/or the compressor shaft is/are rotatably mounted in the support structure.

If a suction side of the pump unit is connected, for example via an oil line that is provided so as to run in the interior space of the support structure, to an oil reservoir, the gear box can be supplied with oil via a separate oil circuit that comprises the pump unit and the oil reservoir in the interior space of the support structure. Here, if the pump unit is driven by the fan or by the compressor, the supply of oil is ensured when the gas turbine engine is in a shut-down state.

If the pump unit comprises at least two pumps, the oil supply to the gear box can be advantageously implemented in a manner adapted to existing installation space conditions.

Provision may be made here for the at least two pumps to be arranged on the same side of the gear box, that is to say on that side of the support structure which faces toward the fan or on that side of the support structure which faces toward the compressor, in receiving regions of the support structure and so as to be distributed over the circumference of the support structure.

Furthermore, it is also possible for at least one of the pumps to be arranged on one side of the gear box, for example on that side which faces toward the fan, and for at least one further pump to be arranged on the other side of the gear box, which then faces toward the compressor.

The gear box may be designed as a space-saving planetary gear box which is distinguished by a low component weight and which has at least one sun gear and/or at least one ring gear and at least one planet carrier. At least one planet gear is rotatably arranged on the planet carrier.

As noted elsewhere herein, the present disclosure may relate to a gas turbine engine. Such a gas turbine engine may comprise an engine core which comprises a turbine, a combustion chamber, a compressor, and a core shaft that connects the turbine to the compressor. Such a gas turbine engine may comprise a fan (having fan blades) which is positioned upstream of the engine core.

Arrangements of the present disclosure can be particularly, although not exclusively, beneficial for fans that are driven via a gear box. Accordingly, the gas turbine engine may comprise a gear box that receives an input from the core shaft and outputs drive for the fan so as to drive the fan at a lower rotational speed than the core shaft. The input to the gear box may be performed directly from the core shaft or indirectly from the core shaft, for example via a spur shaft and/or a spur gear. The core shaft may be rigidly connected to the turbine and the compressor, such that the turbine and the compressor rotate at the same rotational speed (wherein the fan rotates at a lower rotational speed). The gear box herein may be configured as a gear box as has been described in more detail above.

The gas turbine engine as described and claimed herein may have any suitable general architecture. For example, the gas turbine engine may have any desired number of shafts, for example one, two or three shafts, that connect turbines and compressors. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft which connects the second turbine to the second compressor. The second turbine, second compressor and second core shaft may be arranged so as to rotate at a higher rotational speed than the first core shaft.

In such an arrangement, the second compressor may be positioned so as to be axially downstream of the first compressor. The second compressor may be arranged so as to receive (for example directly receive, for example via a generally annular duct) flow from the first compressor.

The gear box may be arranged so as to be driven by that core shaft (for example the first core shaft in the example above) which is configured to rotate (for example during use) at the lowest rotational speed. For example, the gear box may be arranged so as to be driven only by that core shaft (for example only by the first core shaft, and not the second core shaft, in the example above) which is configured to rotate (for example during use) at the lowest rotational speed. Alternatively thereto, the gear box may be arranged so as to be driven by one or a plurality of shafts, for example the first and/or the second shaft in the example above.

In the case of a gas turbine engine which is described and claimed herein, a combustion chamber may be provided so as to be axially downstream of the fan and the compressor(s). For example, the combustion chamber can lie directly downstream of the second compressor (for example at the exit of the latter), if a second compressor is provided. By way of further example, the flow at the exit of the compressor may be supplied to the inlet of the second turbine, if a second turbine is provided. The combustion chamber may be provided upstream of the turbine(s).

The or each compressor (for example the first compressor and the second compressor as described above) may comprise any number of stages, for example multiple stages. Each stage may comprise a row of rotor blades and a row of stator vanes, the latter potentially being variable stator vanes (in that the angle of incidence of said stator vanes can be variable). The row of rotor blades and the row of stator blades may be axially offset from one another.

The or each turbine (for example the first turbine and the second turbine as described above) may comprise any number of stages, for example multiple stages. Each stage may comprise a row of rotor blades and a row of stator blades. The row of rotor blades and the row of stator blades may be axially offset from one another.

Each fan blade may be defined as having a radial span extending from a root (or a hub) at a radially inner location flowed over by gas, or at a 0% span width position, to a tip at a 100% span width position. The ratio of the radius of the fan blade at the hub to the radius of the fan blade at the tip may be less than (or of the order of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range delimited by two of the values in the previous sentence (that is to say that the values may form upper or lower limits). These ratios may be referred to in general as the hub-to-tip ratio. The radius at the hub and the radius at the tip can both be measured at the leading periphery part (or the axially frontmost periphery) of the blade. The hub-to-tip ratio refers, of course, to that portion of the fan blade which is flowed over by gas, that is to say the portion that is situated radially outside any platform.

The radius of the fan can be measured between the engine centerline and the tip of the fan blade at the leading periphery of the latter. The diameter of the fan (which can simply be double the radius of the fan) may be larger than (or of the order of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter may be in an inclusive range delimited by two of the values in the previous sentence (that is to say that the values may form upper or lower limits).

The rotational speed of the fan may vary during use. Generally, the rotational speed is lower for fans with a comparatively large diameter. Purely by way of non-limiting example, the rotational speed of the fan under cruise conditions may be less than 2500 rpm, for example less than 2300 rpm. Purely by way of a further non-limiting example, the rotational speed of the fan under cruise conditions for an engine having a fan diameter in the range from 250 cm to 300 cm (for example 250 cm to 280 cm) may also be in the range from 1700 rpm to 2500 rpm, for example in the range from 1800 rpm to 2300 rpm, for example in the range from 1900 rpm to 2100 rpm. Purely by way of a further non-limiting example, the rotational speed of the fan under cruise conditions for an engine having a fan diameter in the range from 320 cm to 380 cm may be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about an axis of rotation. This rotation results in the tip of the fan blade moving with a velocity Uₜᵢₚ. The work done by the fan blades on the flow results in an enthalpy rise dH in the flow. A fan tip loading can be defined as dH/Uₜᵢₚ², where dH is the enthalpy rise (for example the 1-D average enthalpy rise) across the fan and Uₜᵢₚ is the (translational) velocity of the fan tip, for example at the leading periphery of the tip (which can be defined as the fan tip radius at the leading periphery multiplied by the angular velocity). The fan tip loading at cruise conditions may be more than (or of the order of): 0.3, 0.31, 0.32, 0.33, 0.34, 0.35, 0.36, 0.37, 0.38, 0.39, or 0.4 (wherein all units in this passage are Jkg⁻¹K⁻1/ms⁻¹)²). The fan tip loading may be in an inclusive range delimited by two of the values in the previous sentence (that is to say that the values may form upper or lower limits).

Gas turbine engines in accordance with the present disclosure can have any desired bypass ratio, wherein the bypass ratio is defined as the ratio of the mass flow rate of the flow through the bypass duct to the mass flow rate of the flow through the core at cruise conditions. In the case of some arrangements, the bypass ratio can be more than (or of the order of): 10, 10.5, 11, 11.5, 12, 12.5, 13, 13.5, 14, 14.5, 15, 15.5, 16, 16.5, or 17. The bypass ratio may be in an inclusive range delimited by two of the values in the previous sentence (that is to say that the values may form upper or lower limits). The bypass duct may be substantially annular. The bypass duct may be situated radially outside the engine core. The radially outer surface of the bypass duct may be defined by an engine nacelle and/or a fan casing.

The overall pressure ratio of a gas turbine engine as described and claimed herein may be defined as the ratio of the stagnation pressure upstream of the fan to the stagnation pressure at the exit of the highest pressure compressor (before the entry to the combustion chamber). By way of non-limiting example, the overall pressure ratio of a gas turbine engine as described and claimed herein at cruising speed may be greater than (or of the order of): 35, 40, 45, 50, 55, 60, 65, 70, 75. The overall pressure ratio may be in an inclusive range delimited by two of the values in the previous sentence (that is to say that the values may form upper or lower limits).

The specific thrust of a gas turbine engine may be defined as the net thrust of the gas turbine engine divided by the total mass flow through the engine. The specific thrust of an engine as described and/or claimed herein at cruise conditions may be less than (or of the order of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range delimited by two of the values in the previous sentence (that is to say that the values may form upper or lower limits). Such gas turbine engines can be particularly efficient in comparison with conventional gas turbine engines.

A gas turbine engine as described and claimed herein may have any desired maximum thrust. Purely by way of a non-limiting example, a gas turbine as described and/or claimed herein may be capable of generating a maximum thrust of at least (or of the order of): 160 kN, 170 kN, 180 kN, 190 kN, 200 kN, 250 kN, 300 kN, 350 kN, 400 kN, 450 kN, 500 kN, or 550 kN. The maximum thrust may be in an inclusive range delimited by two of the values in the previous sentence (that is to say that the values may form upper or lower limits). The thrust referred to above may be the maximum net thrust at standard atmospheric conditions at sea level plus 15 degrees C. (ambient pressure 101.3 kPa, temperature 30 degrees C.) in the case of a static engine.

During use, the temperature of the flow at the entry to the high-pressure turbine can be particularly high. This temperature, which can be referred to as TET, may be measured at the exit to the combustion chamber, for example directly upstream of the first turbine blade, which in turn can be referred to as a nozzle guide vane. At cruising speed, the TET may be at least (or of the order of): 1400 K, 1450 K, 1500 K, 1550 K, 1600 K, or 1650 K. The TET at cruising speed may be in an inclusive range delimited by two of the values in the previous sentence (that is to say that the values may form upper or lower limits). The maximum TET in the use of the engine may be at least (or of the order of), for example: 1700 K, 1750 K, 1800 K, 1850 K, 1900 K, 1950 K, or 2000 K. The maximum TET may be in an inclusive range delimited by two of the values in the previous sentence (that is to say that the values may form upper or lower limits). The maximum TET may occur, for example, under a high thrust condition, for example under a maximum take-off thrust (MTO) condition.

A fan blade and/or an airfoil portion of a fan blade as described herein can be manufactured from any suitable material or a combination of materials. For example, at least a part of the fan blade and/or of the airfoil can be manufactured at least in part from a composite, for example a metal matrix composite and/or an organic matrix composite, such as carbon fiber. By way of further example, at least a part of the fan blade and/or of the airfoil can be manufactured at least in part from a metal, such as a titanium-based metal or an aluminum-based material (such as an aluminum-lithium alloy) or a steel-based material. The fan blade may comprise at least two regions which are manufactured using different materials. For example, the fan blade may have a protective leading periphery, which is manufactured using a material that is better able to resist impact (for example of birds, ice, or other material) than the rest of the blade. Such a leading periphery may, for example, be manufactured using titanium or a titanium-based alloy. Thus, purely by way of example, the fan blade may have a carbon-fiber-based or aluminum-based body (such as an aluminum-lithium alloy) with a titanium leading periphery.

A fan as described herein may comprise a central portion from which the fan blades can extend, for example in a radial direction. The fan blades may be attached to the central portion in any desired manner. For example, each fan blade may comprise a fixing device which can engage with a corresponding slot in the hub (or disk). Purely by way of example, such a fixing device may be in the form of a dovetail that can be inserted into and/or engage with a corresponding slot in the hub/disk in order for the fan blade to be fixed to the hub/disk. By way of further example, the fan blades can be formed integrally with a central portion. Such an arrangement may be referred to as a blisk or a bling.

Any suitable method may be used to manufacture such a blisk or such a bling. For example, at least some of the fan blades can be machined from a block and/or at least some of the fan blades can be attached to the hub/disk by welding, such as linear friction welding, for example.

The gas turbine engines as described and claimed herein may or may not be provided with a variable area nozzle (VAN). Such a variable area nozzle can allow the exit cross section of the bypass duct to be varied during use. The general principles of the present disclosure can apply to engines with or without a VAN.

The fan of a gas turbine engine as described and claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or the gas turbine engine at the midpoint (in terms of time and/or distance) between end of climb and start of descent.

Purely by way of example, the forward speed at the cruise condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example in the magnitude of Mach 0.8, in the magnitude of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions may correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example of the order of 11,000 m. The cruise conditions may correspond to standard atmospheric conditions at any given altitude in these ranges.

Purely by way of example, the cruise conditions may correspond to the following: a forward Mach number of 0.8; a pressure of 23,000 Pa; and a temperature of −55 degrees C.

As used anywhere herein, “cruising speed” or “cruise conditions” may mean the aerodynamic design point. Such an aerodynamic design point (or ADP) may correspond to the conditions (including, for example, the Mach number, environmental conditions, and thrust requirement) for which the fan operation is designed. This may mean, for example, the conditions under which the fan (or the gas turbine engine) has the optimum efficiency in terms of construction.

During use, a gas turbine engine as described and claimed herein can operate at the cruise conditions defined elsewhere herein. Such cruise conditions can be determined by the cruise conditions (for example the mid-cruise conditions) of an aircraft to which at least one (for example 2 or 4) gas turbine engine can be fastened in order to provide the thrust force.

It is self-evident to a person skilled in the art that a feature or parameter described in relation to one of the above aspects may be applied to any other aspect, unless these are mutually exclusive. Furthermore, any feature or any parameter described here may be applied to any aspect and/or combined with any other feature or parameter described here, unless these are mutually exclusive.

Embodiments will now be described, by way of example, with reference to the figures.

in which:

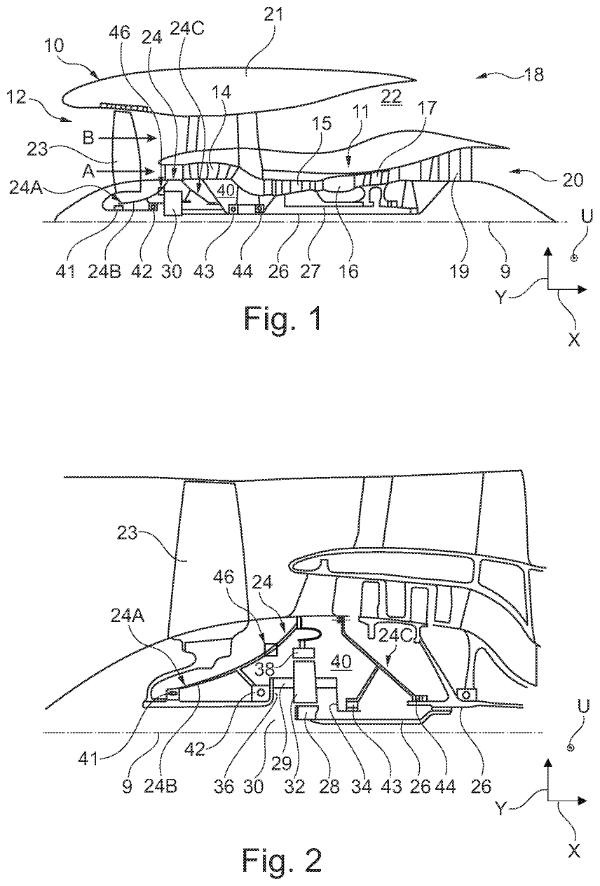

FIG. 1 shows a longitudinal sectional view of a gas turbine engine;

FIG. 2 shows an enlarged partial longitudinal sectional view of an upstream portion of a gas turbine engine;

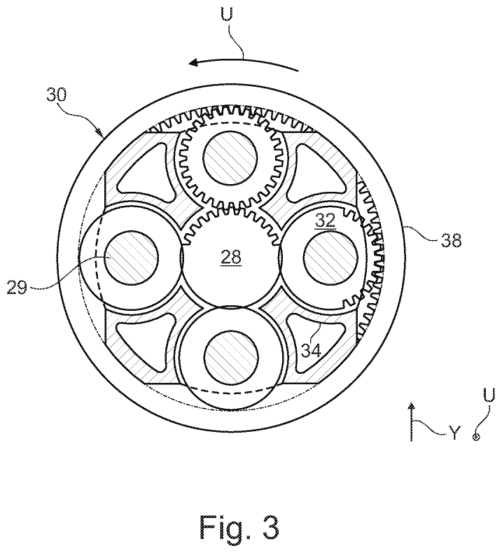

FIG. 3 shows an isolated illustration of a gear box for a gas turbine engine;

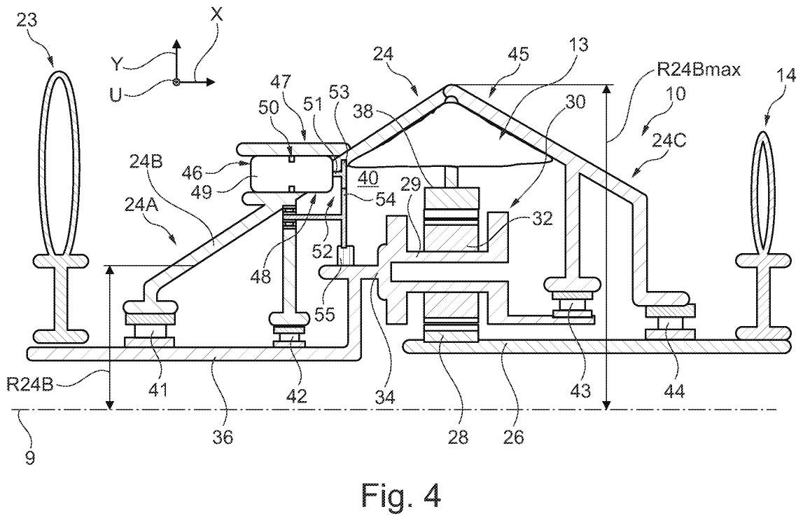

FIG. 4 shows a highly schematic illustration of the region shown in FIG. 2 of a further exemplary embodiment of the gas turbine engine, in which a pump is integrated in that region of the support structure which faces toward the fan;

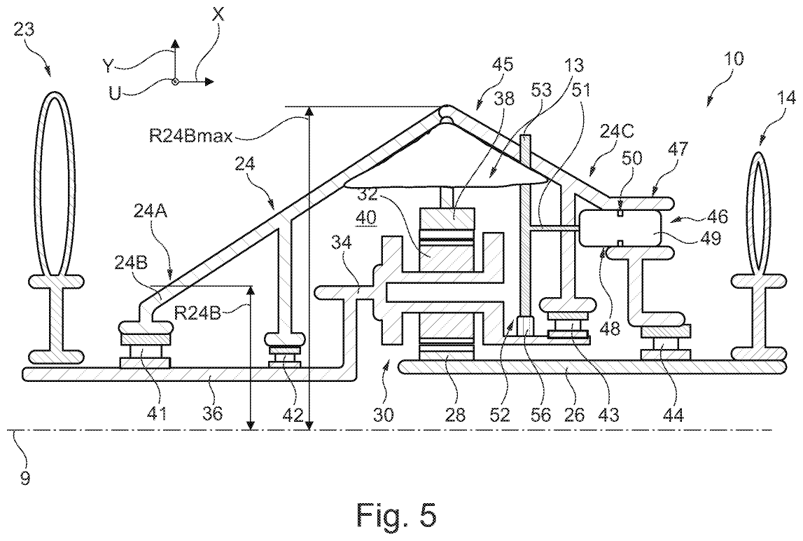

FIG. 5 shows an illustration corresponding to FIG. 4 of a further exemplary embodiment of the gas turbine engine, in which the pump is integrated in a region of the support structure facing toward the compressor and is connected in terms of drive to a planet carrier of the gear box;

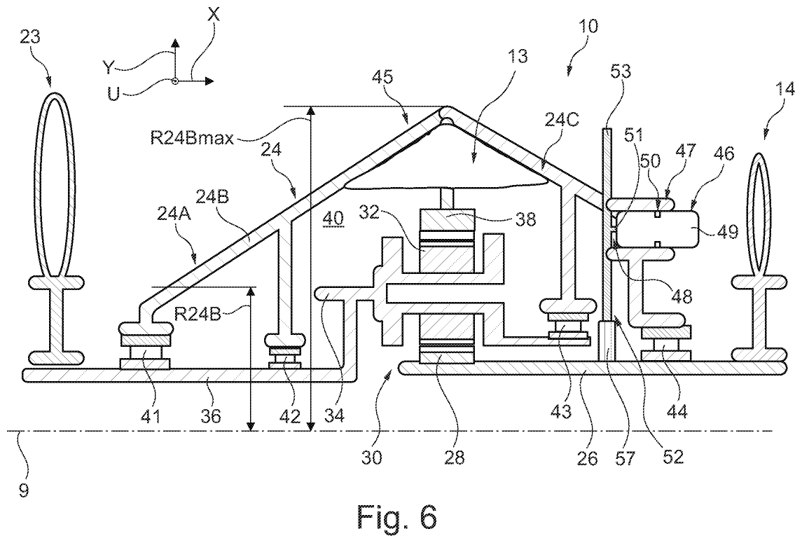

FIG. 6 shows an illustration corresponding to FIG. 5 of a further embodiment of gas turbine engine, in which the pump is connected in terms of drive to a compressor shaft;

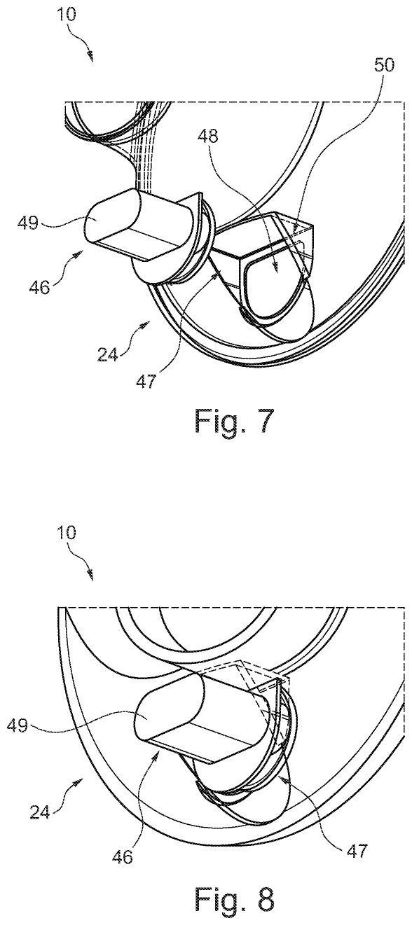

FIG. 7 shows a schematic three-dimensional partial view of the support structure and of the pump unit in the uninstalled state of the pump unit;

FIG. 8 shows an illustration of the support structure and of the pump unit corresponding to FIG. 7 in the installed state of the pump unit; and

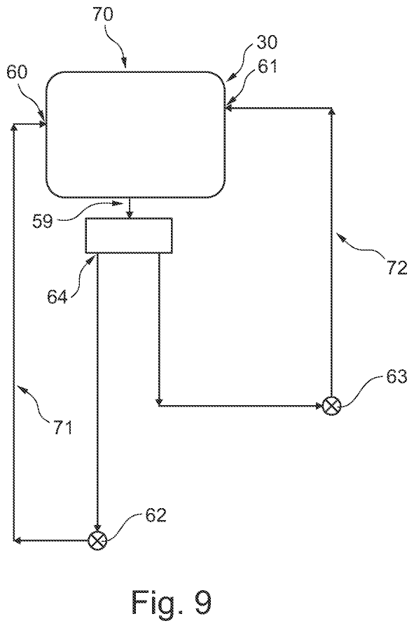

FIG. 9 shows a first embodiment of an oil circuit of the gas turbine engine according to FIG. 1.

FIG. 1 illustrates a gas turbine engine 10 with a main axis of rotation 9. The engine 10 comprises an air intake 12 and a fan or a thrust fan 23 that generates two air flows: a core air flow A and a bypass air flow B. The gas turbine engine 10 comprises a core 11 which receives the core air flow A. In the sequence of axial flow, the engine core 11 comprises a compressor or a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 by way of a compressor shaft or a shaft 26 and a gear box or epicyclic gear box 30. The shaft 26 herein is also referred to as the core shaft.

During use, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive said turbines, before being expelled through the nozzle 20 to provide a certain propulsive thrust. The high-pressure turbine 17 drives the high-pressure compressor 15 by way of a suitable connecting shaft 27, which is also referred to as the core shaft. The fan 23 generally provides the majority of the propulsion force. The epicyclic gear box 30 is a reduction gear box.

An exemplary arrangement for a geared fan gas turbine engine 10 is shown in FIG. 2. The low-pressure turbine 19 (see FIG. 1) drives the shaft 26, which is coupled to a sun gear 28 of the epicyclic gear box arrangement 30. Multiple planet gears 32, which are coupled to one another by means of a planet carrier 34, are situated radially outside the sun gear 28 and mesh with the latter, and are in each case arranged so as to be rotatable on carrier elements 29 which are connected in a rotationally fixed manner to the planet carrier 34 and which are shown in more detail in FIG. 3. The planet carrier 34 limits the planet gears 32 to orbiting around the sun gear 28 in a synchronous manner while enabling each planet gear 32 to rotate about its own axis on the carrier elements 29. The planet carrier 34 is coupled by way of linkages 36 to the fan 23 so as to drive the rotation of the latter about the engine axis 9. Radially to the outside of the planet gears 32 and meshing therewith is an annulus or ring gear 38 that is coupled, via linkages 40, to a stationary support structure 24.

It is noted that the terms “low-pressure turbine” and “low-pressure compressor” as used herein can be taken to mean the lowest pressure turbine stage and the lowest pressure compressor stage (that is to say not including the fan 23) respectively and/or the turbine and compressor stages that are connected to one another by the connecting shaft 26 with the lowest rotational speed in the engine (that is to say not including the gear box output shaft that drives the fan 23). In some documents, the “low-pressure tur- bine” and the “low-pressure compressor” referred to herein may alternatively be known as the “intermediate-pressure turbine” and “intermediate-pressure compressor”. Where such alternative nomenclature is used, the fan 23 can be referred to as a first compression stage or lowest-pressure compression stage.

The epicyclic gear box 30 is shown in greater detail by way of example in FIG. 3. Each of the sun gear 28, the planet gears 32 and the ring gear 38 comprise teeth about their periphery to mesh with the other gears. However, for clarity, only exemplary portions of the teeth are illustrated in FIG. 3. Although four planet gears 32 are illustrated, it will be apparent to the person skilled in the art that more or fewer planet gears 32 may be provided within the scope of protection of the claimed invention. Practical applications of an epicyclic gear box 30 generally comprise at least three planet gears 32.

The epicyclic gear box 30 illustrated by way of example in FIGS. 2 and 3 is a planetary gear box, in which the planet carrier 34 is coupled to a linkage 36 or to a fan shaft, wherein the ring gear 38 is fixed. However, any other suitable type of epicyclic gear box 30 may be used. As a further example, the epicyclic gear box 30 may be a star arrangement, in which the planet carrier 34 is held fixed, with the ring gear (or annulus) 38 allowed to rotate. In the case of such an arrangement, the fan 23 is driven by the ring gear 38. As a further alternative example, the gear box 30 can be a differential gear box in which both the ring gear 38 and the planet carrier 34 are allowed to rotate.

It will be appreciated that the arrangement shown in FIGS. 2 and 3 is merely exemplary, and various alternatives fall within the scope of protection of the present disclosure. Purely by way of example, any suitable arrangement can be used for positioning the gear box 30 in the engine 10 and/or for connecting the gear box 30 to the engine 10. By way of a further example, the connections (such as the linkages 36, 40 in the example of FIG. 2) between the gear box 30 and other parts of the engine 10 (such as the input shaft 26, the output shaft and the fixed structure 24) may have a certain degree of stiffness or flexibility. By way of a further example, any suitable arrangement of the bearings between rotating and stationary parts of the engine (for example between the input and output shafts of the gear box and the fixed structures, such as the gear box casing) may be used, and the disclosure is not limited to the exemplary arrangement of FIG. 2. For example, where the gear box 30 has a star arrangement (described above), the person skilled in the art would readily understand that the arrangement of output and support linkages and bearing positions would usually be different from those shown by way of example in FIG. 2.

Accordingly, the present disclosure extends to a gas turbine engine having an arbitrary arrangement of gear box types (for example star-shaped or planetary), support structures, input and output shaft arrangement, and bearing positions.

Optionally, the gear box may drive additional and/or alternative components (for example the intermediate-pressure compressor and/or a booster compressor).

Other gas turbine engines in which the present disclosure can be used may have alternative configurations. For example, such engines may have an alternative number of compressors and/or turbines and/or an alternative number of connecting shafts. By way of further example, the gas turbine engine shown in FIG. 1 has a split flow nozzle 20, 22, meaning that the flow through the bypass duct 22 has a dedicated nozzle that is separate from and radially outside the engine core nozzle 20. However, this is not restrictive, and any aspect of the present disclosure can also apply to engines in which the flow through the bypass duct 22 and the flow through the core 11 are mixed or combined before (or upstream of) a single nozzle, which may be referred to as a mixed flow nozzle. One or both nozzles (whether mixed or split flow) can have a fixed or variable region. Although the example described relates to a turbofan engine, the disclosure can be applied, for example, to any type of gas turbine engine, such as, for example, an open rotor engine (in which the fan stage is not surrounded by an engine nacelle) or a turboprop engine.

The geometry of the gas turbine engine 10, and components thereof, is or are defined using a conventional axis system which comprises an axial direction X (which is aligned with the axis of rotation 9), a radial direction Y (in the direction from bottom to top in FIG. 1), and a circumferential direction U (perpendicular to the view in FIG. 1). The axial, radial and circumferential directions X, Y and U are mutually perpendicular.

The gear box 30 is, in the manner shown in more detail in each of FIGS. 4 to 6, arranged radially in an interior space 40 which is delimited by the support structure 24 fixed with respect to a casing and which is provided radially within the core air flow A. Furthermore, the planet carrier 34 and the sun gear 28, which is connected rotationally conjointly to the compressor shaft 26, are mounted rotatably in the support structure 24 by means of bearings 41 to 44. The fan shaft 36 is also mounted rotatably in the support structure 24 by means of the bearing 41. In addition, the compressor shaft 26 is supported on the support structure 24 via the bearing 44.

The interior space 40 is configured to be oil-tight in relation to the surroundings of the support structure 24, and in relation to the core air flow A, in a radially outer region 45. Oil that is sprayed from the gear box 30 during operation is captured and collected in the radially outer region 45. This avoids uncontrolled distribution of the oil in the gas turbine engine 10. The oil volume collected in the radially outer region is illustrated in more detail in the drawing at reference designation 13.

Furthermore, a pump unit 46 is provided, by means of which oil can be applied to the gear box 30 and which is connected in terms of drive to the gear box 30. Here, the support structure 24 is configured with a receiving region 47 for the pump unit 46, into which receiving region 47 the pump unit 46 can be introduced from a region outside the interior space 40 via an opening 48 of the support structure 24 and from which receiving region 47 the pump unit 46 can be removed via the opening 48. The pump unit 46 is fixedly connected to the support structure 24, for example by means of screw connections or the like.

In the exemplary embodiments of the gas turbine engine 10 illustrated in FIG. 4 and FIG. 5, the pump unit 46 protrudes in each case into the interior space 40 from the region outside the interior space 40 through the opening 48 of the support structure 24. In these two exemplary embodiments of the gas turbine engine 10, the receiving region 47 is in each case arranged entirely outside the interior space 40. In addition, in the gas turbine engine 10 as per FIG. 4, the pump unit 46, the receiving region 47 and the opening 48 are provided in a region 24A of the support structure 24 facing toward the fan 23.

Proceeding from that region 24A of the support structure 24 which faces toward the fan 23 in the direction of a region 24C of the support structure 24 facing toward the compressor 14, a radial spacing R24B between a wall region 24B of the support structure 24 and the main axis of rotation 9 of the gas turbine engine 10 initially increases up to a maximum R24Bmax. The radial spacing R24B then decreases again. The maximum R24Bmax of the radial spacing R24B is provided at least approximately above that region of the gas turbine engine 10 between the fan 24 and the low-pressure compressor 14 in which the gear box 30 is arranged. It is thus achieved in a simple manner that, as the components of the gear box 30 rotate, oil sprayed therefrom is captured and collected in the radially outer region 45 of the support structure 24 with little effort.

A sealing unit 50 is provided in each case between a casing 49 of the pump unit 46 and the support structure 24 in the region of the opening 48 in order to prevent an undesired escape of oil via the opening 48.

A drive shaft 51 of the pump unit 46 according to FIG. 4 and according to FIG. 5 is connected in terms of drive to the planet carrier 34 via a gear box unit 52. The gear box unit 52 according to FIG. 4 comprises a first spur gear 53 which is connected to the drive shaft 51 of the pump unit 46. The spur gear 53 meshes with a further spur gear 54 which is rotatably mounted in the support structure 24A and which meshes with a spur gear region 55 of the planet carrier 34.

In general, in all of the embodiments of the gas turbine engine 10 illustrated in the drawing, the pump unit 46 delivers oil to regions of the gear box 30 that are not illustrated in any more detail, which may be rolling bearings or plain bearings of the planet gears 32 and further regions of the gear box 30, irrespective of the direction of rotation of the drive shaft 51 of the pump unit 46.

The arrangement of the pump unit 46 shown in FIG. 4 offers the possibility of the pump unit 46 being driven, and supplying oil to the gear box 30, as a result of a rotation of the fan 23 even if the gas turbine engine 10 is in a shut-down state and no drive torque is being imparted to the gear box 30 by the low-pressure compressor 14. Furthermore, the pump unit 46 can also be driven by the fan 23 if, in the event of damage, no torque can be introduced into the gear box 30 via the compressor shaft 26 or the sun gear 28. The gear box 30 can thus be supplied with oil by means of the pump unit 46 over a large operating range of the gas turbine engine 10. In addition, the arrangement of the pump unit 46 shown in FIG. 4 offers the possibility of the pump unit 46 being exchanged or replaced with little effort during maintenance, with the fan 23 having been uninstalled.

By contrast to this, in the exemplary embodiments of the gas turbine engine 10 shown in FIG. 5 and FIG. 6, the pump unit 46 is provided in a region 24C of the support structure 24 which faces toward the low-pressure compressor 14. In the exemplary embodiment of the gas turbine engine 10 shown in FIG. 5, the pump unit 46 protrudes into the interior space 40 of the support structure 24, whereas the pump unit 46 according to FIG. 6 is arranged virtually entirely outside the interior space 40, in the receiving region 47.

The drive shaft 51 of the pump unit 46 according to FIG. 5 is in turn connected rotationally conjointly to the spur gear 53, which is arranged entirely in the interior space 40 and is illustrated as having been pivoted together with the pump unit 46 into the plane of the drawing and which meshes directly with a spur gear region 56 of the planet carrier 34 and which is mounted in the support structure 24 in a manner not illustrated in any more detail.

By contrast to this, in the exemplary embodiment of the gas turbine engine 10 according to FIG. 6, the spur gear 53 of the gear box unit 52, which is likewise mounted rotatably in the support structure 24 and arranged entirely in the interior space and illustrated as having been pivoted together with the pump unit into the plane of the drawing, meshes with a spur gear region 57 of the compressor shaft 26.

The arrangement of the pump unit 46 according to FIG. 5 and FIG. 6 offers the possibility of performing maintenance on the pump unit 46 with the low-pressure compressor 14 having been uninstalled and optionally without uninstalling the spur gear 53. In addition, the likelihood of the pump unit 46 of the gas turbine engine 10 according to FIG. 5 or according to FIG. 6 being damaged as a result of a blade breakage in the region of the fan 23 is lower than that in the case of the embodiment of the gas turbine engine 10 according to FIG. 4.

The connection of the pump unit 46 to the compressor shaft 26 in terms of drive in turn offers the possibility of operating the pump unit 46 at higher drive rotational speeds and of dimensioning the pump unit 46 to be smaller in relation to the connection to the planet carrier 34 or to the fan shaft 36.

FIG. 7 and FIG. 8 each show a three-dimensional partial view of the support structure 24 and of the pump unit 46. The pump unit 46 is illustrated in FIG. 7 in the uninstalled state and in FIG. 8 in the installed operating state.

In general, provision may be made for a suction side of the pump unit 46 to be directly connected to the radially outer region 45 and to draw oil in from there. It is furthermore also possible for the pump unit 46 to be connected to an oil reservoir, which may be arranged within the interior space 40, within and outside the interior space 40 or outside the interior space 40, or to be connectable to such an oil reservoir. It is possible here for the oil reservoir to be provided in the radially outer region 45 or for oil that has collected in the radially outer region 45 to be introduced into such an oil reservoir. In addition, the pump unit may also deliver oil directly from the radially outer region 45 and from such an oil reservoir, or from other oil reservoirs of the gas turbine engine 10, in the direction of the gear box 30 in order to reliably avoid a deficiency of supply to the gear box 30.

FIG. 9 shows a first embodiment of an oil system 70 of the gas turbine engine 10. The oil system 70 comprises a first oil circuit 71 and a second oil circuit 72. The first oil circuit 71 and the second oil circuit 72 are fluidically coupled to a common outlet 59 of the gear box 30. Furthermore, the first oil circuit 71 and the second oil circuit 72 are respectively fluidically coupled to a separate inlet 60 and 61 of the gear box 30. The first oil circuit 71 and the second oil circuit 72 are each configured with a pump 62, 63. It is possible here for the pump 62, the pump 63 or both pumps 62 and 63 to correspond to the pump unit 46.

The outlet 59 of the gear box 30 comprises a device 64 which is designed in such a way that oil from the gear box 30 is introduced into the first oil circuit 71 and into the second oil circuit 72.

### LIST OF REFERENCE SIGNS

9 Main axis of rotation
10 Gas turbine engine
11 Core
12 Air inlet
13 Oil volume
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass duct
23 Thrust fan
24 Support structure
24A Region of the support structure
24B Wall region of the support structure
24C Region of the support structure
26 Shaft, connecting shaft
27 Connecting shaft
28 Sun gear
29 Carrier element
30 Gear box, planetary gear box
32 Planet gear
34 Planet carrier
36 Linkage
38 Ring gear
40 Interior space
41 to 44 Bearings
45 Radially outer region of the support structure
46 Pump unit
47 Receiving region
48 Opening
49 Housing of the pump unit
50 Sealing unit
51 Drive shaft
52 Gear box unit
53 Spur gear
54 Further spur gear
55 to 57 Spur gear region
59 Outlet
60, 61 Inlet
62, 63 Pump
64 Device
70 Oil system
71 First oil circuit
72 Second oil circuit
A Core air flow
B Bypass air flow
R24B Radial spacing
R24Bmax Maximum of the radial spacing
U Circumferential direction
X Axial direction
Y Radial direction

1. A gas turbine engine of an aircraft with a gear box,
which gear box is arranged at least partially radially in an interior space, which is delimited by a support structure fixed with respect to a casing and which is provided radially within a core air flow, of the support structure,
wherein at least shafts of the gear box are rotatably mounted in the support structure
wherein the interior space is configured to be oil-tight in relation to the surroundings of the support structure, at least in a radially outer region,
wherein a pump unit is provided, by means of which oil can be applied to the gear box and which is connected in terms of drive to the gear box, and wherein the support structure is configured with a receiving region for the pump unit, into which receiving region the pump unit can be introduced from a region outside the interior space via an opening of the support structure and from which receiving region the pump unit can be removed via the opening.

2. The gas turbine engine as claimed in claim 1, wherein the pump unit projects into the interior space from the region outside the interior space through the opening of the support structure.

3. The gas turbine engine as claimed in claim 1, wherein a sealing unit is provided between a casing of the pump unit and the support structure in the region of the opening.

4. The gas turbine engine as claimed in claim 1, wherein a fan and a compressor are provided, between which the gear box is arranged in an axial direction and which are connected to one another via the gear box.

5. The gas turbine engine as claimed in claim 1, wherein, proceeding from a region facing toward the fan in the direction of a region facing toward the compressor, a radial spacing between a wall region of the support structure and an axis of rotation of the gas turbine engine initially increases to a maximum and then decreases again, wherein the maximum is provided at least approximately above that region between the fan and the compressor in which the gear box is arranged.

6. The gas turbine engine as claimed in claim 4, wherein the receiving region and the opening of the support structure are provided in that region of the support structure which faces toward the fan or in that region of the support structure which faces toward the compressor.

7. The gas turbine engine as claimed in claim 1, wherein the receiving region is provided entirely outside the interior space, outside and within the interior space, or entirely within the interior space.

8. The gas turbine engine as claimed in claim 1, wherein a drive shaft of the pump unit is operatively connected to a shaft of the gear box.

9. The gas turbine engine as claimed in claim 8, wherein a gear box unit is provided between the drive shaft of the pump unit and the shaft of the gear box.

10. The gas turbine engine as claimed in claim 4, wherein a first shaft of the gear box is connected to the fan via a fan shaft, and a second shaft of the gear box is operatively connected to the compressor via a compressor shaft.

11. The gas turbine engine as claimed in claim 10, wherein at least the first shaft of the gear box is rotatably mounted in that region of the support structure which faces toward the fan.

12. The gas turbine engine as claimed in claim 10, wherein at least the second shaft of the gear box is rotatably mounted in that region of the support structure which faces toward the compressor.

13. The gas turbine engine as claimed in claim 10, wherein the fan shaft and/or the compressor shaft are/is rotatably mounted in the support structure.

14. The gas turbine engine as claimed in claim 1, wherein a suction side of the pump unit is connected, preferably via an oil line which runs at least partially in the interior space of the support structure, to an oil reservoir.

15. The gas turbine engine as claimed in claim 1, wherein the pump unit comprises at least two pumps.
